(19) United States
(12) Patent Application Publication
(10) Pub. No.: US 2025/0222764 A1
(43) Pub. Date: Jul. 10, 2025

(54) ACCELERATOR DEVICE

(71) Applicant: DENSO CORPORATION, Kariya-city (JP)

(72) Inventors: Takuto KITA, Kariya-city (JP); Yuta FUJINAKA, Kariya-city (JP)

(21) Appl. No.: 19/094,036

(22) Filed: Mar. 28, 2025

Related U.S. Application Data
(63) Continuation of application No. PCT/JP2023/033045, filed on Sep. 11, 2023.

(30) Foreign Application Priority Data
Sep. 30, 2022 (JP) 2022-158996

(51) Int. Cl. B60K 26/02

(52) U.S. Cl. CPC B60K 26/021

(57) ABSTRACT

An accelerator device includes: a pedal lever movable in accordance with a pedaling operation; a drive source configured to generate a drive force when being energized; a power transmission mechanism including an actuator lever that abuts to the pedal lever at a lever abutment point, and configured to transmit the drive force of the drive source to the pedal lever and to apply a reaction force that is a force in a direction opposite to a pedaling direction of the pedal lever; a pedaling amount detector detecting a pedaling amount of the pedal lever; and a controller including a drive force calculator configured to calculate the drive force output from the drive source and to control operation of the drive source. The drive force calculator calculates the drive force corresponding to a target reaction force, based on the pedaling amount.

### CROSS REFERENCE TO RELATED APPLICATION

The present application is a continuation application of International Patent Application No. PCT/JP2023/033045 filed on Sep. 11, 2023, which designated the U.S. and claims the benefit of priority from Japanese Patent Applications No. 2022-158996 filed on Sep. 30, 2022. The entire disclosures of all of the above applications are incorporated herein by reference.

### TECHNICAL FIELD

The present disclosure relates to an accelerator device.

### BACKGROUND

Conventionally, a vehicle accelerator pedal device having a reaction force application mechanism is known. For example, a reaction force application mechanism includes a drive source that generates a reaction force, a transmission member that transmits the reaction force generated by the drive source to a pedal side arm, and a bracket that supports the drive source, so as to apply, to the pedal side arm, a reaction force against a pedaling operation force applied to a pad.

### SUMMARY

An accelerator device according to an aspect of the present disclosure includes a pedal lever, a drive source, a power transmission mechanism, a pedaling amount detector, and a controller. The pedal lever is movable in accordance with a pedaling operation. The drive source is configured to generate a drive force when being energized. The power transmission mechanism includes an actuator lever that abuts to the pedal lever at a lever abutment point, and is configured to transmit the drive force of the drive source to the pedal lever and to apply a reaction force that is a force in a direction opposite to a pedaling direction of the pedal lever. The pedaling amount detector detects a pedaling amount of the pedal lever.

The controller includes a drive force calculator configured to calculate the drive force output from the drive source and to control operation of the drive source. The drive force calculator calculates the drive force corresponding to a target reaction force, based on the pedaling amount. In such manner, the reaction force applied to the pedal lever can be appropriately controlled.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing an accelerator device according to an embodiment;

FIG. 2 is a block diagram showing an actuator controller according to the embodiment;

FIG. 3 is a schematic diagram showing an abutment state in which a pedal lever and an actuator lever abut to each other when the pedal lever is fully-closed or fully-opened according to the embodiment;

FIG. 4 is an enlarged view showing part IV in FIG. 3;

FIG. 5 is a diagram showing a reaction force applied when a pedal lever is depressed according to one embodiment;

FIG. 6 is a block diagram showing a drive force calculator according to one embodiment; and

FIG. 7 is an explanatory diagram showing a map used for calculating a target torque according to one embodiment.

### DETAILED DESCRIPTION

In an accelerator device, when an abutment distance and an abutment angle with a power transmission member change depending on a pedaling angle, a reaction force transmitted to a driver changes even if a same torque is applied by an actuator.

It is an object of the present disclosure to provide an accelerator device capable of appropriately controlling a reaction force applied to a pedal lever.

Hereinafter, embodiments of the present disclosure will be described.

### Embodiment

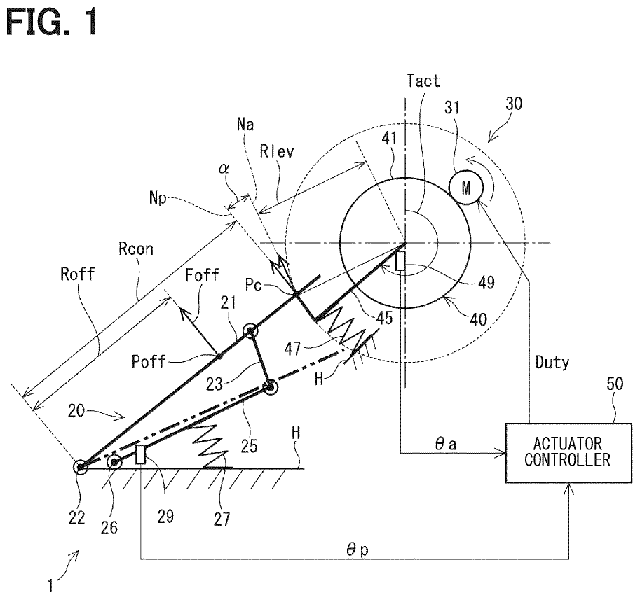

An accelerator device according to the present disclosure is described with reference to the drawings. An accelerator device according to an embodiment is shown in FIGS. 1 to 7. As shown in FIG. 1, an accelerator device 1 includes a pedal lever 20, an actuator 30, an actuator controller 50 and the like.

The pedal lever 20 includes a pad 21, an arm 23, a pedal 25, and the like, and is driven as a whole by a driver's pedaling operation, or the like. The pad 21 is provided to be operable by the driver's pedaling operation. The pad 21 is rotatably supported by a fulcrum member 22 provided at a housing H. FIG. 1 illustrates a so-called floor type (i.e., organ type) pedal in which the pad 21 is provided to extend in a direction along one surface of the housing H. However, a suspension type (i.e., pendant type) pedal may also be used. In the present embodiment, components of a housing which are not driven by a drive of a motor 31 or by pedaling of the pedal lever 20, such as a pedal housing and a motor housing, are collectively referred to as the “housing H.”

The arm 23 connects the pad 21 and the pedal 25. The pedal 25 has one end rotatably supported by the housing H by a fulcrum member 26 and an other end connected to the arm 23. In such manner, when a driver operates the pad 21, the pad 21, the arm 23 and the pedal 25 are driven as one body in an integrated manner. A pedal opening sensor 29 that detects a pedal opening degree θp is provided on one end side of the pedal 25.

A pedal biasing member 27 is a compression coil spring, one end of which is fixed to the pedal 25 and an other end of which is fixed to the housing H, and which biases the pedal 25 in an accelerator closing direction. In FIG. 1 and the like, a fully-opened accelerator state or a fully-closed accelerator state is indicated by a two-dot chain line as appropriate.

The actuator 30 includes the motor 31 as a drive source, and a power transmission mechanism 40. The motor 31 is, for example, a DC motor with brushes. The drive force of the motor 31 is transmitted to the pedal lever 20 via the power transmission mechanism 40. Here, the actuator 30 can be made of a series of components that transmit power from the motor 31 to the pedal lever 20 via the power transmission mechanism 40.

The power transmission mechanism 40 includes a gear set 41, an actuator lever 45, and an actuator lever biasing member 47. The gear set 41 is made of a motor gear that rotates integrally with a motor shaft, and a plurality of gears that mesh with the motor gear, and transmits the drive force of the motor 31 to the actuator lever 45. An actuator sensor 49 for detecting a rotational position is provided on any of the gears constituting the gear set 41.

The actuator lever 45 has one end connected to the gear set 41 and an other end abutting to the pedal lever 20. In such manner, the drive force of the motor 31 is transmitted to the pedal lever 20 via the power transmission mechanism 40. In FIG. 1, the other end of the actuator lever 45 abuts to the pad 21, but it may be configured to abut to the arm 23 or the pedal 25.

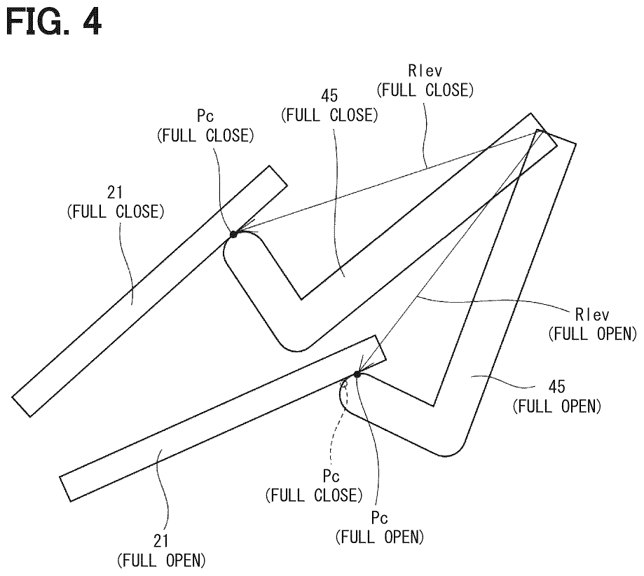

The actuator lever biasing member 47 is a compression coil spring, and biases the actuator lever 45 in a reaction force application direction. The actuator lever biasing member 47 has a spring force set so that the actuator lever 45 always abuts to the pedal lever 20. An abutment point between the pedal lever 20 (specifically, the pad 21) and the actuator lever 45 is referred to as a lever abutment point Pc. In the present embodiment, a surface of the actuator lever 45 that abuts to the pad 21 is formed in a spherical shape (see FIG. 4).

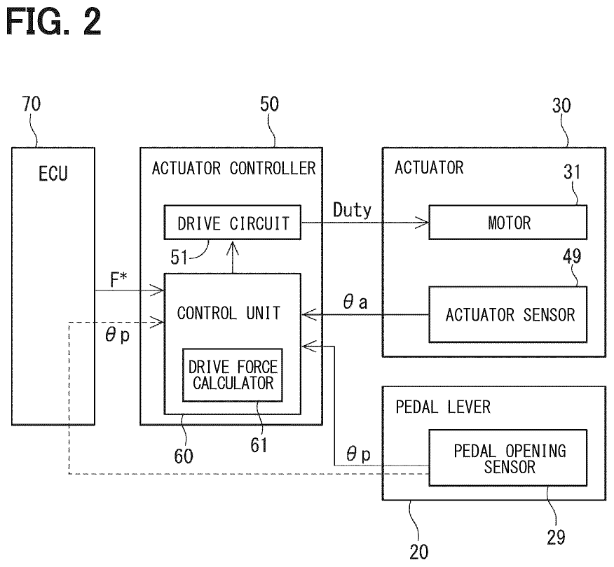

As shown in FIGS. 1 and 2, the actuator controller 50 includes a drive circuit 51 and a control unit 60 (i.e., controller). The drive circuit 51 is configured, for example, by an H-bridge circuit, and has a switching element (not shown) for switching a supply of electric current to the motor 31.

As shown in FIG. 2, the control unit 60 has a microcomputer as a main component, and includes a CPU, ROM, RAM, I/O, all of which are not shown, and bus lines connecting these components and the like. Each process executed by the control unit 60 may be software processing or may be hardware processing. The software processing may be implemented by causing the CPU to execute a program. The program may be stored beforehand in a memory device such as a ROM or the like, that is, in a computer-readable, non-transitory, tangible storage medium. The hardware processing may be implemented by a special purpose electronic circuit.

The control unit 60 includes a drive force calculator 61 as a functional block. The drive force calculator 61 calculates a target torque T* so that a reaction force corresponding to a target reaction force F* obtained from a higher-level ECU 70 is output. The control unit 60 controls drive of the motor 31 by controlling the drive circuit 51 with a duty corresponding to the target torque T*.

The drive force calculator 61 calculates the target torque T* based on an actuator angle θa based on a detection value of the actuator sensor 49 or the pedal opening degree θp based on a detection value of the pedal opening sensor 29. The pedal opening degree θp may be obtained directly from the pedal opening sensor 29 as indicated by a solid line arrow, or may be obtained from the higher-level ECU 70 via CAN (Controller Area Network) communication or the like as indicated by a broken line arrow.

The control unit 60 learns, as a reference position, the detection value of the actuator sensor 49 when the pedal lever 20 is in a fully-closed state, and converts an angle by using a gear ratio, a lever length ratio, and the like, thereby converting the actuator angle θa to a pedal opening degree θp. In the present embodiment, when a starter switch such as an ignition switch or the like is turned on, it is assumed that the pedal lever 20 is fully closed, and the detection value of the actuator sensor 49 at such timing is learned as a reference position. Also, calibration may be performed by comparing the detection value of the pedal opening sensor 29 with the detection value of the actuator sensor 49 while a vehicle is traveling, for example or in a similar situation. The following description focuses on the calculation of the drive force using the pedal opening degree θp.

As shown in FIG. 1, in a case where a point where the driver's foot abuts the pad 21 is set as a reaction force off point Poff, when the pedal lever 20 is in the fully-closed state, a reaction force Foff applied to the reaction force off point Poff is expressed by the following equation (1). In the equation (1), Tact is a motor torque which is an actuator drive force, Rlev is a lever abutment distance which is a distance between a rotation center of the actuator lever 45 and a lever abutment point Pc, Rcon is a pedal abutment distance which is a distance between a rotation center of the pad 21 and the lever abutment point Pc, and Roff is a distance between the rotation center of the pad 21 and the reaction force off point Poff. Further, an angle α is a relative angle between the reaction force application direction from the actuator lever 45 and a reaction force output direction to the pad 21. Specifically, the relative angle α is an angle between a normal line Na of a straight line connecting the rotation center of the actuator lever 45 and the lever abutment point Pc, and a normal line Np connecting the rotation center of the pad 21 and the lever abutment point Pc. For simplicity, the equation (1) is calculated geometrically and does not take into account an inclination of the abutment point, and the like. The same applies to the following equations.

$$Foff = Tact / Rlev \times cos α \times Rcon / Roff \qquad Equation ( 1 )$$

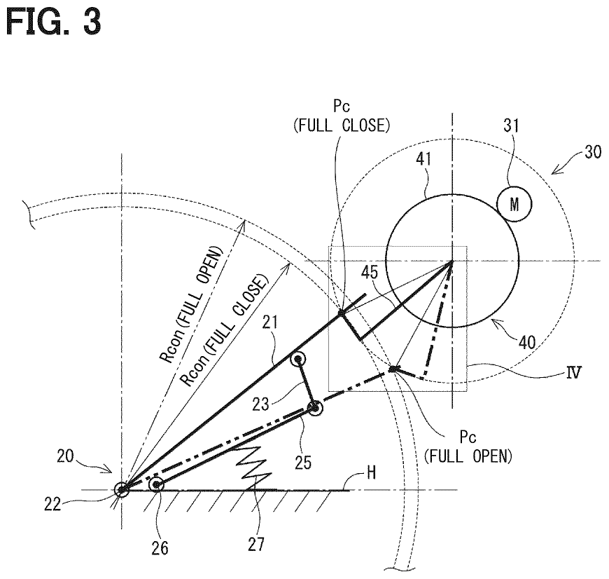

FIGS. 3 and 4 respectively show abutment states in which the pedal lever 20 abuts to the actuator lever 45, when the pedal lever 20 is fully closed or fully open. As shown in FIG. 3, when the pedal lever 20 is stepped on from the fully-closed state, a position of the lever abutment point Pc shifts, and the pedal abutment distance Rcon is different from that in the fully-closed state. Further, as shown in FIG. 4, when the pedal lever 20 is stepped on from the fully-closed state, an abutment point of the actuator lever 45 also shifts microscopically, so that the lever abutment distance Rlev is also different from that in the fully-closed state. Therefore, when a constant motor torque Tact is output, the reaction force Foff applied at the reaction force off point Poff changes according to the pedal opening degree θp.

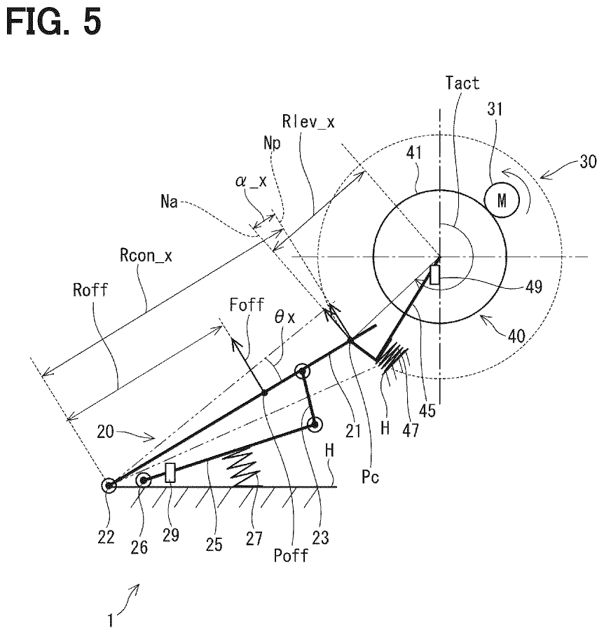

As shown in FIG. 5, a pedal abutment distance when the pedal opening degree θp is a certain opening degree θx is designated as Rcon_x, a lever abutment distance when the pedal opening degree θp is designated as Rlev_x, and a relative angle when the pedal opening degree θp is designated as α_x, the reaction force Foff applied at the reaction force off point Poff is expressed by the following equation (2).

$$Foff = Tact / Rlev\_x \times cosα\_x \times Rcon\_x / Roff \qquad Equation ( 2 )$$

Therefore, in the present embodiment, the motor torque Tact is corrected according to the abutment state so that the reaction force Foff applied at the reaction force off point Poff becomes the target reaction force F* regardless of the pedal opening degree θp. When a motor torque when the pedal lever is fully-closed corresponding to the target reaction force F* is designated as Tact_b, the corrected motor torque Tact_x when the pedal opening degree θp is a certain opening degree θx is expressed by an equation (3).

$$Tact\_x = Tact\_b \times ( Rlev\_x / Rlev ) \times ( cos α / cosα\_x ) \times ( Rcon / Rcon\_x ) \qquad Equation ( 3 )$$

The pedal abutment distance Rcon, the lever abutment distance Rlev, and the relative angle α are determined in accordance with the pedal opening degree θp. Therefore, the corrected motor torque Tact_x can be calculated based on the pedal opening degree θp.

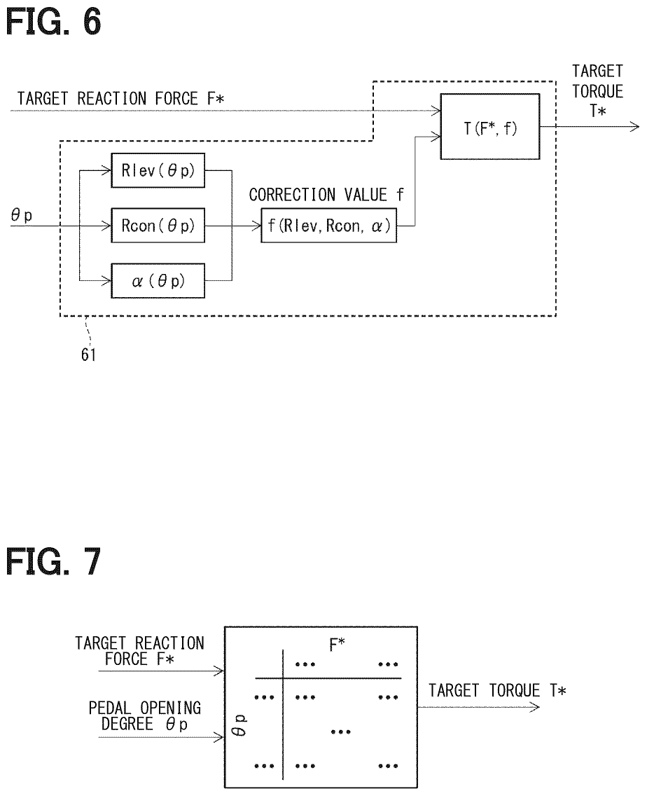

As shown in FIG. 6, the drive force calculator 61 calculates the lever abutment distance Rlev, the pedal abutment distance Rcon, and the relative angle α using the pedal opening degree θp, and calculates a correction value f using the calculated lever abutment distance Rlev, the pedal abutment distance Rcon, and the relative angle α. The correction value f corresponds to a coefficient portion by which the motor torque Tact_b at a time when the pedal lever is fully closed in the equation (3) is multiplied. The drive force calculator 61 uses the target reaction force F* and the correction value f to calculate a target torque T* corresponding to the pedal opening degree θp.

Also, as shown in FIG. 7, each coefficient may be mapped, and the target torque T* may be calculated by map calculation using the target reaction force F* and the pedal opening degree θp as arguments. Note that, when the actuator angle θa is used instead of the pedal opening degree θp to calculate the target torque T*, a map may be used in which the target reaction force F* and the actuator angle θa are used as arguments.

As described above, the accelerator device 1 of the present embodiment includes the pedal lever 20, the motor 31, the power transmission mechanism 40, the pedal opening sensor 29, and the control unit 60. The pedal lever 20 operates according to the pedaling operation. The motor 31 generates a drive force when energized. The power transmission mechanism 40 includes the actuator lever 45 that abuts to the pedal lever 20 at the lever abutment point Pc, and transmits the drive force of the motor 31 to the pedal lever 20 to apply a reaction force in the opposite direction to the pedaling direction of the pedal lever 20. The pedal opening sensor 29 detects the pedal opening degree θp, which is the amount of pedaling of the pedal lever 20.

The control unit 60 includes the drive force calculator 61 that calculates the drive force output from the motor 31, and controls drive of the motor 31. The drive force calculator 61 calculates a drive force corresponding to the target reaction force F* based on the pedal opening degree θp. By estimating the abutment state between the pedal lever 20 and the actuator lever 45 according to the amount of pedaling of the pedal lever 20 and correcting the drive force, a reaction force is applicable to the pedal lever 20 with high accuracy regardless of the pedaling state.

The drive force calculator 61 calculates the lever abutment distance Rlev, the pedal abutment distance Rcon, and the relative angle α based on the pedal opening degree θp, and calculates a drive force corresponding to the target reaction force F* using the calculated lever abutment distance Rlev, pedal abutment distance Rcon, and the relative angle α. The lever abutment distance Rlev is the distance between the rotation center of the actuator lever 45 and the lever abutment point Pc, and the pedal abutment distance Rcon is the distance between the rotation center of the pedal lever 20 and the lever abutment point Pc. Further, the relative angle α is the angle between (a) the normal line Na to a line connecting the rotation center of the actuator lever 45 and the lever abutment point Pc, and (b) the normal line Np to a line connecting the rotation center of the pedal lever 20 and the lever abutment point Pc. In such manner, it is possible to appropriately estimate the abutment state between the actuator lever 45 and the pedal lever 20, and to calculate the drive force with high accuracy.

The pedaling amount detector in the present embodiment is the pedal opening sensor 29 provided on the pedal lever 20. In such manner, it is possible to calculate the drive force based on existing sensor values.

Further, the pedaling amount detector may be the actuator sensor 49 provided in the power transmission mechanism 40. In such manner, it is possible to perform drive force calculation as a stand-alone system on an actuator 30 side. Further, by providing the actuator sensor 49 and by comparing with the pedal opening sensor 29, a malfunction such as sticking or the like is detectable.

The control unit 60 learns the detection value of the actuator sensor 49 when the pedal lever 20 is in a fully-closed position. In such manner, it is possible to reduce calculation errors caused by variations in an amount of pedaling of the actuator lever 45 due to assembly errors or the like, thereby the drive force is calculable with high accuracy.

The power transmission mechanism 40 includes the actuator lever biasing member 47 that biases the actuator lever 45 in a full-close direction of the pedal lever 20. By appropriately setting a biasing force, the actuator lever 45 and the pedal lever 20 constantly abut to each other, so that the actuator angle θa and the pedal opening degree θp have a 1:1 correspondence, making conversion easy. Further, the abutment state of the actuator lever 45 can be stabilized so that the actuator lever 45 does not separate when pedaling the pedal lever 20.

In the embodiment, the motor 31 corresponds to a “drive source,” the pedal opening sensor 29 and the actuator sensor 49 correspond to a “pedaling amount detector,” and the actuator lever biasing member 47 corresponds to an “elastic member.” The pedal opening degree θp corresponds to a “pedaling amount.” Further, since the actuator angle θa can be converted to the pedal opening degree θp, it may be regarded as a “pedaling amount.”

### Other Embodiments

In the above-described embodiment, the actuator lever is in constant abutment to the pedal lever by the elastic member. In other embodiments, the actuator lever and the pedal lever may be driven as one body using something other than an elastic member, or the elastic member may be omitted. When no elastic member is provided and the actuator lever and the pedal lever are separatable from each other, it is necessary to perform correction processing based on electric current flow information such as a value of an electric current at the time when the actuator lever and the pedal lever abut to each other.

In the above-described embodiment, the drive source is a DC motor having a brush. In other embodiments, a motor other than a DC motor having a brush or something other than a motor may also be used as the drive source. Further, the configuration of the power transmission mechanism, the arrangement of parts and the like may be different from those in the above-described embodiment.

The present disclosure may also be configured such that the power transmission mechanism includes an elastic member that biases the actuator lever in a full-close direction of the pedal lever.

The control unit and the method thereof in the present disclosure may be realized by a dedicated computer provided by configuring a processor and a memory programmed to execute one or more functions embodied by a computer program. Alternatively, the control unit and the method according to the present disclosure may be realized by a dedicated computer provided by configuring a processor with one or more dedicated hardware logic circuits. Alternatively, the control unit and the method according to the present disclosure may be realized by using one or more dedicated computers constituted as a combination of (a) the processor and the memory programmed to execute one or more functions and (b) a processor with one or more hardware logic circuits.

Further, the computer programs may be stored, as instructions to be executed by a computer, in a tangible, non-transitory computer-readable medium.

The present disclosure is not limited to the above-described embodiments, but various modifications may be made further within the scope of the present disclosure without departing from the spirit of the disclosure.

The present disclosure has been made according to the embodiments. However, the present disclosure is not limited to such embodiments and structures. The present disclosure also encompasses various modifications and variations within the scope of equivalents. Further, various combinations and formations, and other combination and formation including one element, more than one element or less than one element are also encompassed within the scope and idea of the present disclosure.

What is claimed is:

1. An accelerator device comprising:
a pedal lever movable in accordance with a pedaling operation;
a drive source configured to generate a drive force when being energized;
a power transmission mechanism including an actuator lever that abuts to the pedal lever at a lever abutment point, and configured to transmit the drive force of the drive source to the pedal lever and to apply a reaction force that is a force in a direction opposite to a pedaling direction of the pedal lever;
a pedaling amount detector detecting a pedaling amount of the pedal lever; and
a controller including a drive force calculator configured to calculate the drive force output from the drive source and to control operation of the drive source, wherein
the drive force calculator calculates the drive force corresponding to a target reaction force based on the pedaling amount, such that the reaction force becomes the target reaction force regardless of the pedaling amount.

2. The accelerator device according to claim 1, wherein
the drive force calculator is configured to
(i) calculate, based on the pedaling amount, at least one of
a lever abutment distance which is a distance between a rotation center of the actuator lever and the lever abutment point,
a pedal abutment distance which is a distance between the rotation center of the pedal lever and the lever abutment point, and
a relative angle between a normal to a line connecting the rotation center of the actuator lever and the lever abutment point and a normal to a line connecting the rotation center of the pedal lever and the lever abutment point, and
(ii) calculate the drive force corresponding to the target reaction force using the calculated at least one of the lever abutment distance, the pedal abutment distance, and the relative angle.

3. The accelerator device according to claim 1, wherein
the pedaling amount detector is provided in the power transmission mechanism.

4. The accelerator device according to claim 3, wherein
the controller learns a detection value of the pedaling amount detector when the pedal lever is in a fully-closed position.

5. The accelerator device according to claim 1, wherein
the pedaling amount detector is provided in the pedal lever.

6. The accelerator device according to claim 1, wherein
the power transmission mechanism includes an elastic member that biases the actuator lever in a full-close direction of the pedal lever.

7. An accelerator device comprising:
a pedal lever movable in accordance with a pedaling operation;
a drive source configured to generate a drive force when being energized;
a power transmission mechanism including an actuator lever that abuts to the pedal lever at a lever abutment point, and configured to transmit the drive force of the drive source to the pedal lever and to apply a reaction force that is a force in a direction opposite to a pedaling direction of the pedal lever;
a pedaling amount sensor detecting a pedaling amount of the pedal lever; and
a controller including at least one of a circuit and a processor having a memory storing computer program code, wherein
the controller is configured to:
calculate the drive force output from the drive source based on the pedaling amount, and
correct the drive force corresponding to a target reaction force, to control the reaction force to become the target reaction force regardless of the pedaling amount, and
to control operation of the drive source based on the corrected drive force.

8. The accelerator device according to claim 1, wherein
the controller is configured to
(i) calculate, based on the pedaling amount, at least one of
a lever abutment distance which is a distance between a rotation center of the actuator lever and the lever abutment point,
a pedal abutment distance which is a distance between the rotation center of the pedal lever and the lever abutment point, and
a relative angle between a normal to a line connecting the rotation center of the actuator lever and the lever abutment point and a normal to a line connecting the rotation center of the pedal lever and the lever abutment point, and
(ii) calculate the drive force corresponding to the target reaction force using the calculated at least one of the lever abutment distance, the pedal abutment distance, and the relative angle.

9. The accelerator device according to claim 7, wherein
the pedaling amount sensor is provided in the power transmission mechanism.

10. The accelerator device according to claim 9, wherein
the controller is configured to learn a detection value of the pedaling amount sensor when the pedal lever is in a fully-closed position.

11. The accelerator device according to claim 7, wherein
the pedaling amount sensor is provided in the pedal lever.
